(19) United States
(12) Patent Application Publication
(10) Pub. No.: US 2007/0202258 A1
(43) Pub. Date: Aug. 30, 2007

(54) Micro-pattern forming apparatus, micro-pattern structure, and method of manufacturing the same

(75) Inventors: Yutaka Yamagata, Kamakura (JP); Hitoshi Ohmori, Itabashi (JP); Hiroshi Kase, Koganei-shi (JP); Hiromi Nonaka, Asaka-shi (JP); Ai Kaneko, Wako-shi (JP); Kazuya Nitta, Wako-shi (JP)

Correspondence Address: OLIFF & BERRIDGE, PLC, P.O. BOX 19928, ALEXANDRIA, VA, 22320, US

(73) Assignees: FUENCE CO., LTD., Tokyo (JP); RIKEN, Wako-shi (JP)

(21) Appl. No.: 11/512,355

(22) Filed: Aug. 30, 2006

(30) Foreign Application Priority Data
Feb. 28, 2006 (JP) 2006-53497

(51) Int. Cl. B05D 1/32; C25D 5/00; B05C 5/00

(52) U.S. Cl. 427/282; 205/80; 118/300

(57) ABSTRACT

There is provided a micro-pattern forming apparatus including an electrospraying part for applying a voltage to a solution containing a sample to electrostatically atomizing the solution; a supporting part (30) for supporting a chip (26), on which the sample in the solution electrostatically atomized by the electrospraying part, is to be deposited; and a fine mask part (24) disposed between the electrospraying part and the supporting part, having a mask pattern for being passed through by the electrostatically atomized solution in order to form a micro-pattern of the sample upon the chip, wherein the mask pattern is made from a photoresist material with concavity and convexity on the side of the supporting part.

### FIELD OF THE INVENTION

The present invention relates to a micro-pattern forming apparatus, a micro-pattern structure, and a method of manufacturing the same. The present invention particularly relates to a micro-pattern forming apparatus to form a micro-pattern of organic materials using a masking means, which is prepared by lithography and reactive ion etching, and the electrospray deposition method, a micro-pattern structure, and a method of manufacturing the same.

### DESCRIPTION OF THE RELATED ART

Techniques for forming fine patterns on a substrate are widely needed. Especially in the field of semiconductor manufacturing, techniques for patterning thin layers or films of inorganic materials mainly including metal, oxide, and nitride by photoresist masking are quite well developed, and techniques for forming patterns of no more than 100 nm in line width are also known to be already in practice. The means mainly used for these patternings are forming thin layers by vacuum deposition (e.g., resistance heating, electron beam heating, sputtering), and etching (dry, wet) with pattern-formed photoresist.

Whereas techniques for fine patterning using materials other than inorganic materials, such as synthetic organic molecules/macromolecules, organic materials, and biomolecules/biomacromolecules (e.g., protein and DNA) are not as well developed. These materials are generally too weak against heat and vacuum to use such a technique as a means of vacuum depositing. Even worse, when the surface of the materials described above is coated with a masking material made from photoresist, for example, in many cases it is impossible to peel off the mask. Furthermore, many materials can be denatured by etching, a powerful chemical reaction, whether dry or wet. This is why such means as screen printing, spotting, and contact printing are used for patternings of organic materials, biomacromolecules and the like, and also such methods as the spin coating method, the blade method, and the spraying method are used as methods of forming thin layers of such materials. These techniques and methods are totally inferior to the patterning techniques for inorganic materials described above, in terms of precision of forming thin layers (films) and patterns.

The electrospray deposition method (the ESD method) was proposed by Morozov and et al. as a method of fabricating biochips. The inventors of the present invention have studied on methods of fabricating biochips using the ESD method and methods of forming micro-nano patterns. They have developed a device for fabricating a large number of microarrays (refer to a document: Japanese Patent Application Publication No.2001-281252), and an immobilizing device using a vibrating element instead of a capillary (refer to a document: Japanese Patent Application Publication No.2003-136005).

Further, the inventors of the present invention have demonstrated that by using a mask made of glass, for example, in the ESD method it is possible to obtain a resolution of several hundred to several tens of μm. It has also been discovered that a line/space resolution of 2 μm can be obtained by a fine stencil mask which is a silicon nitride thin layer or film. Silicon nitride thin layers have, however, enormous internal stress, thus they are difficult to handle. The problems with silicon nitride thin layers are described as follows.
(1) A silicon nitride thin layers is extremely fragile. (The internal stress in it becomes larger in the process, thus easily destructible and exceedingly difficult to handle.)
(2) It is extremely difficult to form concavity and convexity on the back of a silicon nitride thin layers.

### (3) It is necessary to use a silicon wafer (a semiconductor) as a reinforcing member, thus a sample becomes attached to the conductive part of the silicon wafer. (The sample becomes wasted.)

Silicon nitride thin layers/films have the problems described above. Therefore, in the current condition, where there are no means for solving these problems, a silicon nitride thin layers cannot be used as a masking means for a micro-pattern forming apparatus. Also, there has been reported about attempts to form a stencil mask with thick photoresist using a self-assembled mono-layer (SAM), but this is not yet in practice.

### DESCRIPTION OF THE INVENTION

As described above, the micro patterning technique has been developed in the field of semiconductor manufacturing. However, because the technique presupposes the use of a powerful etching agent on a substrate of an inorganic material, which is coated with a masking agent, it has been impossible to apply the micro-pattern technique used in the field of semiconductor manufacturing directly on organic materials including macromolecules that can be easily denatured and altered (typically, protein). This is why, as described above, in the ESD method for biochips, techniques for forming micro-patterns with a masking means using glass, silicon nitride thin layers, and etc., have been developed. However, such a glass mask can only have several tens μm in resolution at best, and a silicon nitride thin layers can have about 2 μm of resolution, but is difficult to handle. Therefore, it has been desired to develop a practical technique for forming fine patterns which can be used on organic materials.

### SUMMARY OF THE INVENTION

In order to solve the above mentioned problems, there is provided in accordance with the present invention a micro-pattern forming apparatus, the apparatus comprising:

electrospraying means for applying a voltage to a solution containing a sample to electrostatically atomize/spray the solution (i.e., using the electrospray deposition method to apply a voltage to said solution to atomize/spray it);

supporting means for supporting a chip (which is grounded to earth), on which the sample in the solution electrostatically atomized/sprayed by said electrospraying means is to be deposited; and

fine masking means disposed between said electrospraying means and said supporting means, having a mask pattern for being passed through by said electrostatically atomized/sprayed solution in order to form a micro-pattern of said sample upon said chip, wherein said mask pattern is made from a photoresist material with concavity and convexity on the side of said supporting means.

According to the present invention, it is possible to form a micro-pattern of an organic material, which micro-pattern is equal to or less than 1 μm in line width. Because the apparatus according to the present invention uses the ESD method, it is further possible to deposit an organic material sample on a substrate as dry minute particles, and also possible to deposit/immobilize minute particles of another sample on these dry minute particles, and thus possible to form a micro-pattern having multiple layers of minute particles like never before. With the concavity and convexity of a mask pattern (i.e., uneven/bumpy surface) on the side of the supporting means, it is possible to prevent the deposited sample on the chip from getting contacted with the mask after the depositing. Thus, according to the present invention, it is possible to form a micro-pattern of an organic material easily and reliably from a small amount of sample, which is finer than ever before.

In an embodiment of the micro-pattern forming apparatus according to the present invention, said electrospraying means uses a capillary. In another embodiment of the micro-pattern forming apparatus according to the present invention, said electrospraying means uses a vibrating element to vibrate said solution. When the vibrating (oscillating) element produces a vibration in the solution, a great number of wave crests are generated on the surface of said solution. These wave crests function as a capillary tip, and the solution can be atomized/sprayed from these wave crests as minute particles. According to the present configuration, a micro-pattern can be formed on the substrate while activities of the samples are retained or without denaturing or altering activities of the samples. Particularly, although the ESD method using a capillary cannot use a sample solution having high electrical conductivity (in such a case as the solution contains a buffer solution having a high electrical conductivity), it can be used in the present configuration because the sample solution can be atomized/sprayed by utilizing both mechanical vibration and electric charge at the same time. Namely, when a protein is immobilized/deposited, the present apparatus has no occasion to remove a buffer solution, which acts to retain proteins in a stable state, from the sample solution, so the present apparatus has the advantages that it can form a micro-pattern in a short period of time and it can also generate or form a thin layer (film) containing a sample having even higher activity. In addition, although the ESD method using a capillary cannot use a sample solution unless it is completely dissolved (because the sample may clog an opening of the capillary tip), the present apparatus can use even a sample having low solubility in a form that the pieces of sample are dispersed in the solution, therefore has a very practical use. Furthermore, in the present configuration the solution can be atomized/sprayed at a higher speed and consequently chips can be manufactured at a higher rate than that in the ESD method using a capillary. Specifically, although the conventional ESD method can process a BSA solution of 5 μg/μl a speed of 1 μl/sec., the micro-pattern forming apparatus using a vibrating element having an atomizing region of 5 mm×5 mm atomizing area according to the present embodiment can process the same solution at a high speed of 10 μl/sec. Furthermore, as to the ESD method using a capillary, in order to increase processing speed, it is necessary to increase the number of capillaries, which leads to such problems as high cost and troublesome maintenance (for example, a capillary is difficult to wash). When using a vibrating element, on the other hand, processing speed and atomizing/spraying efficiency can be increased simply by extending an area of the vibrating element, thus the present apparatus has such remarkable advantages as low cost and easy maintenance. The principle of the present configuration is to vibrate the sample solution to generate many wave crests on the surface of the sample solution so that minute particles of the sample solution can be formed and jumped out of the wave crests. If electric charge is applied to the sample solution at the same time, the forming of the minute particles is urged by repulsion force caused by electrostatics. Additionally the formed minute particles never make contacts mutually because of the electrostatic repulsion force, and the minute particles are split into more minute clusters (i.e., fine particles) under the electrostatic force. For these reasons, more significant advantage of the synergistic effect of the present apparatus can be obtained than when only either vibration or voltage is applied.

In yet another embodiment of the micro-pattern forming apparatus according to the present invention, the concavity and convexity formed in the mask pattern of said fine masking means is formed by the steps of:

forming a pattern(s) for forming concavity and convexity made from a photoresist material (on a substrate), with use of lithography;

forming a fluorocarbon layer/layer on this pattern for forming concavity and convexity, with use of reactive ion etching;

forming said mask pattern made from a photoresist material on this fluorocarbon layer, with use of lithography; and

peeling said mask pattern off from said fluorocarbon layer on said substrate. Thus, with combination of lithography and reactive ion etching, a fine mask with concavity and convexity can be produced.

In yet another embodiment of the micro-pattern forming apparatus according to the present invention, the fine masking means has a reinforcing rib being made from a photoresist material. A mask with strength enough to handle easily can be obtained by having the reinforcing rib. The mask has to be replaced by another suitable one depending on the intended micro-pattern. When replacing it, the thin fine masking means should be treated carefully. The reinforcing rib can enhance the strength of the mask so that it will be remarkably easier to handle the mask.

The fine mask used in the micro-pattern forming apparatus described above is manufactured by the following steps. Namely, a method of manufacturing a fine mask for the micro-pattern forming apparatus comprises the steps of:

forming a pattern for forming concavity and convexity comprising a photoresist material on a substrate, with use of lithography;

forming a fluorocarbon layer/film on said substrate on which said pattern for forming concavity and convexity is formed, with used of reactive ion etching;

forming a mask pattern made from a photoresist material on said substrate on which said fluorocarbon layer is formed, with use of lithography;

forming a reinforcing rib pattern comprising a photoresist material on said substrate on which said mask patter is formed, with use of lithography; and

peeling said mask pattern off from said fluorocarbon layer, and to obtain a fine mask including said reinforcing rib pattern and said mask pattern, which has the concavity and convexity depending on the form of said pattern for forming concavity and convexity.

By way of easy explanation the aspect of the present invention has been described as the apparatuses (i.e., devices), however it is understood that the present invention may be realized as methods corresponding to the apparatuses, as well as chips (i.e., micro-pattern structures) formed/manufactured by these apparatuses. For example, according to another aspect of the present invention, there is provided a micro-pattern structure (a chip). the structure

is a micro-pattern structure formed by one of said micro-pattern forming apparatuses; and

comprises a cluster including particles of an organic material of several tens of nanometers.

According to yet another aspect of the present invention, there is provided a method of manufacturing a micro-pattern structure (chip) of an organic material by one of said micro-pattern forming apparatuses.

According to the present invention, it is possible to form a micro-pattern of an organic material no more than several μm or even nanometer order in line width. Also, as to the smallest line width of the produced micro-pattern, a mask as a thick photoresist can form a pattern having a smaller width than that of the mask because of electrostatic funneling/convergence effect. When resolution of a thick photoresist is approximately 400 nm, a micro-pattern of approximately 100 nm in line width can be formed.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a schematic diagram of a micro-pattern forming apparatus according to the present invention;

FIG. 2 is a flowchart showing the general outline of the mask forming process;

FIG. 3a is a SEM micrograph of a stencil mask (a fine masking means) formed in the process described above;

FIG. 3b is a SEM micrograph of a stencil mask (a fine masking means) formed in the process described above;

FIG. 3c is a SEM micrograph of a stencil mask (a fine masking means) formed in the process described above;

FIG. 3d is a SEM micrograph of a stencil mask (a fine masking means) formed in the process described above;

FIG. 4a is a SEM micrograph of a line-shaped stencil mask;

FIG. 4b is a SEM micrograph of a line-shaped stencil mask;

FIG. 4c is a SEM micrograph of a line-shaped stencil mask;

FIG. 4d is a SEM micrograph of a line-shaped stencil mask;

FIG. 5a is a SEM micrograph of an example of deposit by the ESD, which is formed by using a fine stencil mask formed in the method above:

FIG. 5b is a SEM micrograph of an example of deposit by the ESD, which is formed by using a fine stencil mask formed in the method above;

FIG. 6 is a schematic diagram showing one example of the basic configuration of a micro-pattern forming apparatus using a vibrating element according to the exemplary embodiment;

FIG. 7 is an exploded perspective view illustrating the parts constituting the micro-pattern forming apparatus of FIG. 6;

FIG. 8 is a perspective view depicting the configuration of an atomizer as an electrospraying means according to the exemplary embodiment, which is provided with wires as a charging means;

FIG. 9 is a pattern diagram representing the principle of the atomizer in a micro-pattern forming apparatus according to the exemplary embodiment;

FIG. 10 is a SEM micrograph of a micro-pattern structure of an organic material formed by a micro-pattern forming apparatus according to the exemplary embodiment;

FIG. 11 is a SEM micrograph of a micro-pattern structure of an organic material formed by a micro-pattern forming apparatus according to the exemplary embodiment; and

FIG. 12 is a SEM micrograph of a micro-pattern structure of an organic electroluminescence material formed with the micro pattern forming apparatus according to the exemplary embodiment.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DESCRIPTION OF THE PREFERRED EMBODIMENTS

Several preferred embodiments of the micro-pattern forming apparatus according to the present invention will be described with reference to the accompanying drawings.

According to the method proposed by the present invention, the application of fluorocarbon layer/film produced by Reactive Ion Etching (RIE) makes it possible to form a structure having concavity and convexity on surfaces of both sides (a structure provided with concave portion and convex portion) and to prevent damage to pattern caused by a mask on plural times patternings through ESD method. In addition, in the embodiments of the present invention, a fine stencil mask usable for ESD method was formed by thick-film photoresist.

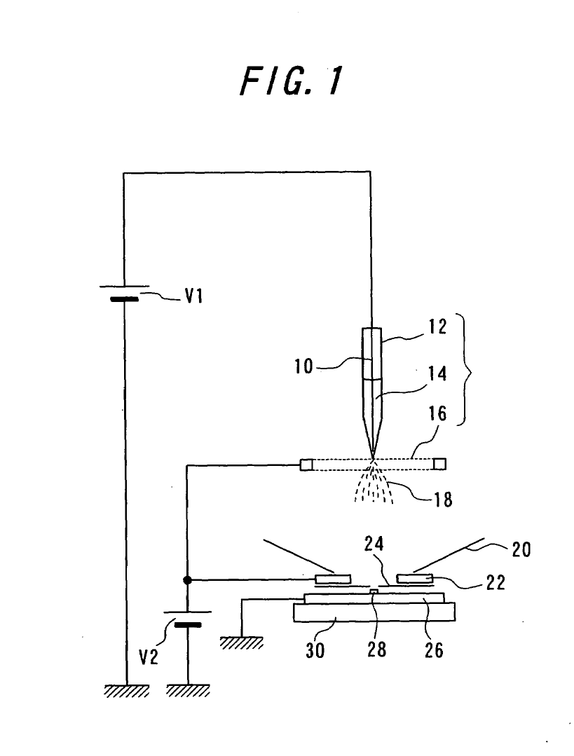

FIG. 1 shows a schematic view of a micro-pattern forming apparatus according to the present invention. This apparatus is almost similar to a conventional electrosplay deposition apparatus except for a fine mask. Solution 14 containing samples is placed in glass capillary 12 having a slim end, to which high voltage is applied via platinum wire 10 by high-voltage power supply V1, the solution is splayed from the capillary end into fine droplets. The sprayed droplets spread in the form of triangular pyramid to form spray frame 18. A guard ring 16, to which voltage is applied by high-voltage power supply V2, is provided around the glass capillary in order not to spread the spray frame 18 to cast away the droplets. Teflon™ shield 20 is preferably provided to prevent the sprayed droplets from spreading. In addition, a collimator electrode 22, to which voltage is also applied from high-voltage power supply V2, is provided. The sprayed droplets are guided to almost center by the guard ring, Teflon™ shield, collimator electrode and the like.

The droplets are rapidly dried in a short period of time in flying to be fine particles and then attracted and deposited onto a conductive substrate 26 by static electricity, and to be sample deposits 28. In this case, if a mask 24 made of an insulating material is placed on the substrate 26, the insulating material (i.e., the mask) is charged in the very short time interval once the electrospraying starts. Accordingly, almost all the sprayed sample can be deposited onto “the substrate” because the mask avoids to deposit the charged particles thereon. A support means 30 for supporting the substrate 26 can be relatively moved or shifted with respect to the mask 24 for the micro-pattern formation.

[A Processing Method for a Fine Stencil Mask (Fine Mask Means)]

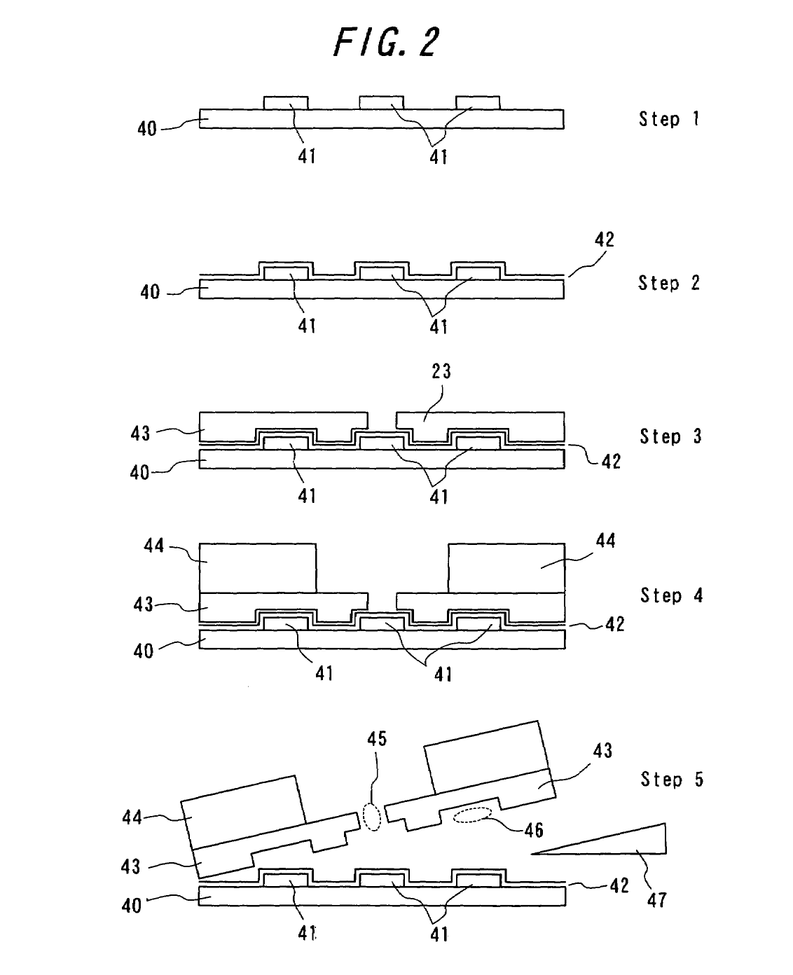

First of all, the mask is required to be made of an insulating material. If the mask is made of a conductive material, the charge will disappear at once and deposits will be formed also on the mask. Next, in order to attain resolution smaller than micron, the thickness of the mask is required to be smaller than micron as well. On the other hand, in order to keep the mechanical strength as the structure, the structure requires appropriate reinforcement. In addition, considering that several times of patternings are carried out, projections/prongs (i.e., concavity and convexity) need to be provided at the bottom surface of the mask so as to prevent contact between the formed patterns and the mask. As the method for producing a mask satisfied with such conditions, a lift-off process by means of thick-film photoresist (SU-8) and fluorocarbon thin layer (film) by RIE has been formulated. FIG. 2 shows an overview of a mask forming process.

### (Step. 1)

Pattern portions 41 (a first SU-8 layer), which form a reverse pattern of the back surface of the mask to be being made, are made from photoresist material to form concavity and convexity, and are formed on the silicon wafer (substrate) 40.

### (Step. 2)

A fluorocarbon thin layer (film) 42 is formed by RIE (about 500 nm).

### (Step. 3)

Mask pattern portions 43 (a second SU-8 layer) are formed (about 1-5 μm thickness).

### (Step. 4)

A structure for reinforcement rib portions 44 (a third SU-8 layer) is formed (50-100 μm thickness).

### (Step. 5)

A cutter 47 is inserted into the interface between the fluorocarbon thin-layer 42 and the mask pattern portion 43 so as to liftoff (separate) the mask pattern portion 43 physically.

The photoresist used in above steps is SU-8 3050 manufactured by Chemistry Microchem Co., Ltd. Other SU-8 series than above (available from several companies) can be used in this process and other thick-film photoresist than SU-8 are also usable.

Thus obtained fine mask has both the mask pattern portion 43 and the reinforcement rib portion 44. The fine mask further has a slit(s) 45, through which samples pass. A concave portion 46 is provided at the bottom side of the mask pattern portion 43 in order to prevent damage of deposited samples.

While the negative resist agent, by which pattern portion is formed as fine mask means and irradiated with a laser light (ultraviolet) to be hardened/cured, is used in the above case, a positive resist agent can be also used.

[Formation of Fluorocarbon Thin-Layer by RIE]

In the above embodiment, fluorocarbon used as a separation layer is formed by means of RIE (reactive ion etching apparatus) from CHF3 gas. Though the composition is not exactly clear because fluorocarbon is made from gas, it is considered that the main chain structure of the fluorocarbon is a form of [—CFₓ—], where x is 1 or 2.

Actual Preparation Condition

By RIE apparatus (SAMCO, Inc.) under the condition of CHF₃ gas flow rate 30 sccm, pressure 40 Pa and RF power 50 W during about 5 to 15 minutes fluorocarbon thin-layer having about 0.5-2 μm thickness is formed.

Alternatively, this fluorocarbon thin-layer may be formed such that cytop (Asahi Glass Co., Ltd.) is spin-coated on the substrate to form the same thin-layer.

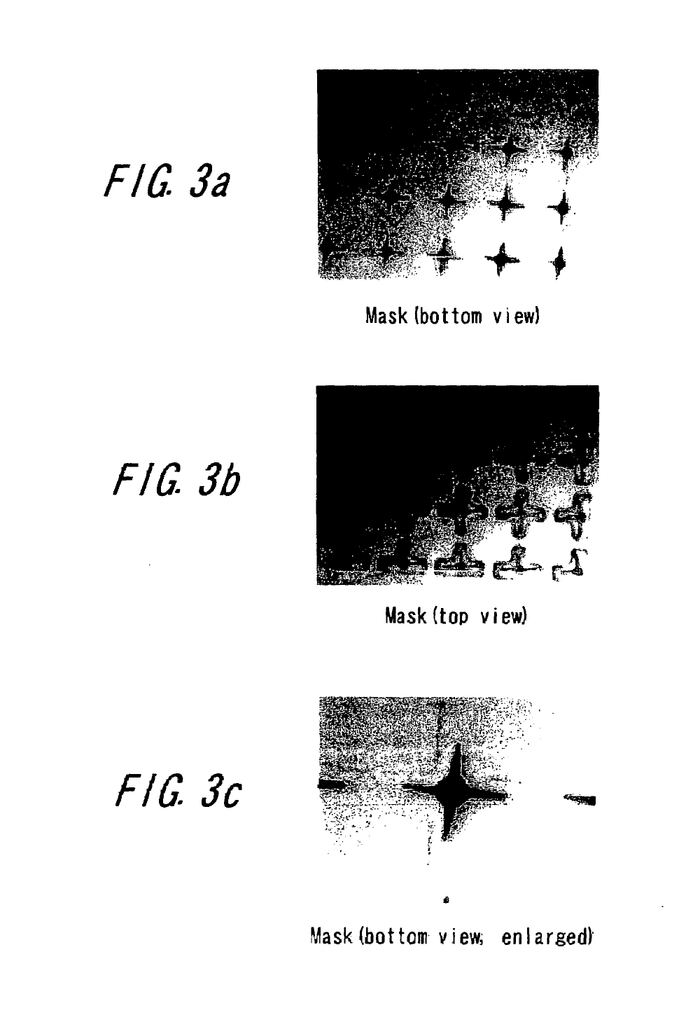

FIG. 3a is a SEM micrograph of a stencil mask (fine mask means) manufactured by the process mentioned above. FIGS. 3a and 3c are bottom views, while FIGS. 3b and 3d are top views. The pitch of this stencil mask is 500 μm, line width is 15 μm and dot diameter is 50 μm. This mask is to form grid patterns and to be used in combination with other linear mask. In order to form a closed pattern like a grid pattern by means of a stencil mask, atomizations of two or more times have to be performed to form two set of deposits. In such case, in order not to damage the formed deposit, concave and convex portions (about 2 μm) are provided at the bottom surface of the mask. The mask is formed as designed with no warpage/deformation even after lift-off it.

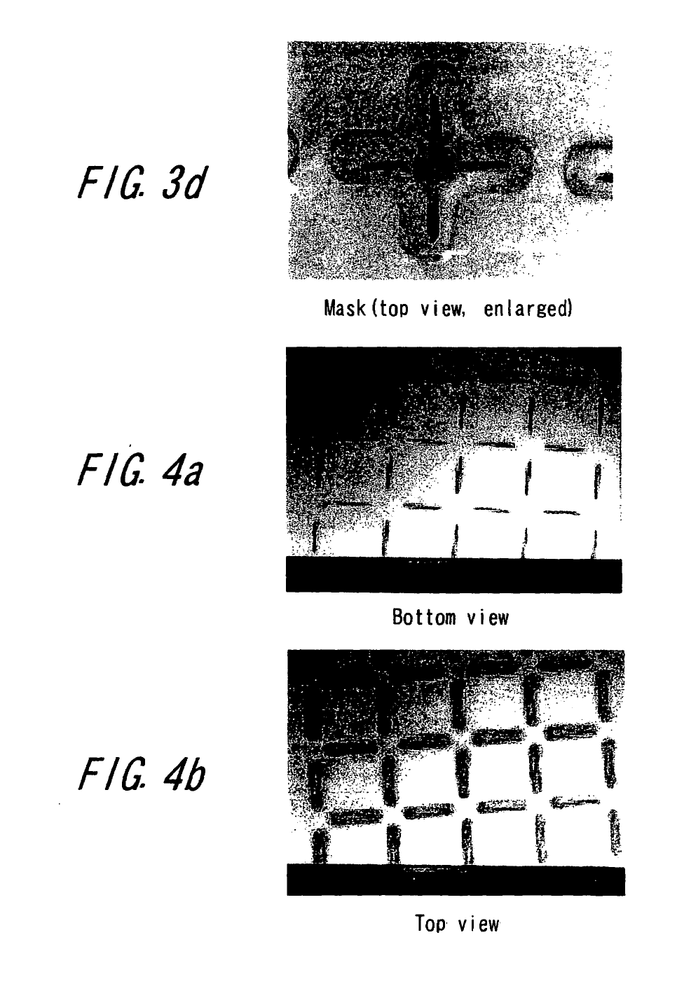

FIG. 4 is a SEM micrograph of a linear stencil mask. The liner mask shown in FIG. 4 is used in combination with the cross-shaped mask shown in FIG. 3. The mask pitch and the line width of the liner mask shown in FIG. 4 are respectively 500 μm and 15 μm.

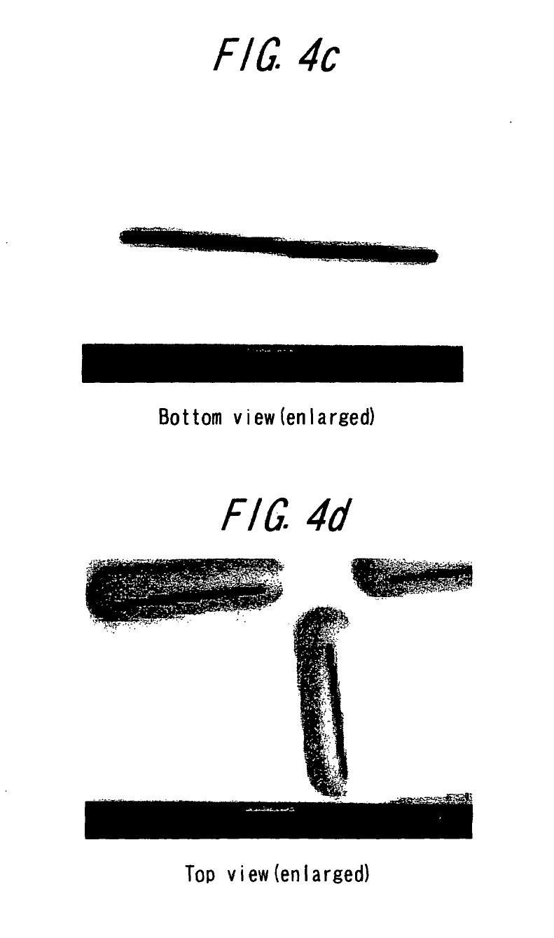

FIG. 5 is a SEM micrograph of an example of deposit using ESD method formed by fine stencil mask which is manufactured by the processing method above. As a sample, CBB (Coomassie Brilliant Blue) R-250 (Wako, Japan), a staining chemical for protein is used. FIG. 5a shows a forming example of deposit by a linear pattern and FIG. 5b shows an example of a pattern formed by two kinds of stencil masks, one used in FIG. 5a and cross-shaped masks. The narrowest line of the pattern in FIG. 5b is approximately 5 μm, which demonstrates that a fine pattern can be formed. In FIG. 5a, the lattice pitch is 500 μm and the line width is 30 μm. In FIG. 5b, the lattice pitch is 200 μm, the line width is 5 μm and the dot (circular region) diameter is 30 μm. In FIG. 5b, though a mask whose line width is 15 μm is used, a pattern having smaller line width of 5 μm than that of the mask is observed due to converging effect by static electricity. The pattern shown in FIG. 5b is formed by repeating two patterning operations, so that two kinds of patterns are layered. In the case layering patterns, no damage on the pattern is observed since the convex portions are provided at the bottom surface. As mentioned above, it is understood that the pattern damage can effectively be prevented due to concavity and convexity provided on the fine mask. The pitch and line width of the formed micro-pattern can be smaller depending on a fine stencil mask.

### Embodiment 2

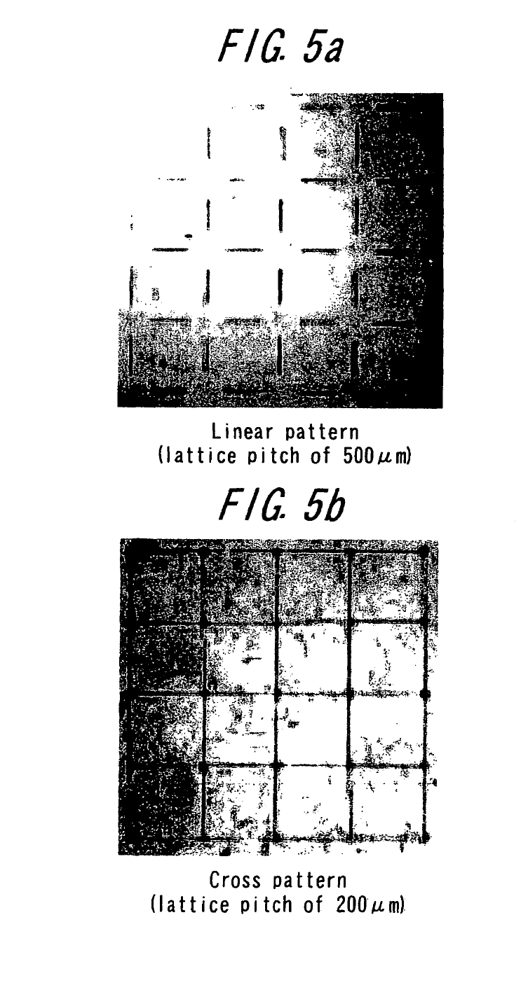

FIG. 6 is a schematic view showing an example of a basic configuration of a micro-pattern forming device using a vibrator. In FIG. 6 an atomizer (atomizing part) 110, a high-voltage power supply 120, a collimator electrode(s) 130, a fluorocarbon-resin shield 140, a mask(s) 150, a sample holder 160, a chamber (casing) 170, precise control solution supply part 180 and a high-frequency power source 190 are provided. As shown in the figure, the atomizer 110 is mainly composed of a vibrator (i.e., substrate) having a flat surface. Solution of protein is provided on the flat surface of the substrate of the atomizer 110 by precise control solution supply part 180. This solution is charged on the substrate by the predetermined voltage provided by the high-voltage power supply 120. Alternatively, particulate after atomization may be charged. The prescribed high-frequency signal from the high-frequency power source 190 is provided on the substrate of the atomizer 110, so that the signal generates the mechanical vibration by the vibrator. The solution is atomized into the charged fine particulates to spatter inside the chamber 170.

These particulates are guided and converged by the collimator electrodes 130, the fluorocarbon resin shield 140 and the mask 150 to deposit (or attach) and stabilize on the sample holder 160 and so that a chip is formed. In order to dry the atomized particulates, the chamber 170 is required to be at low humidity or in a dry condition. According to the embodiment, a drying agent is placed in the chamber 170 while other various methods are possible such as using a circulation system injecting/exhausting dried air or a decompression (vacuum) system so that the atomized particulates can be dried more rapidly with low humidity or in a dry condition to improve the activity of the deposited material.

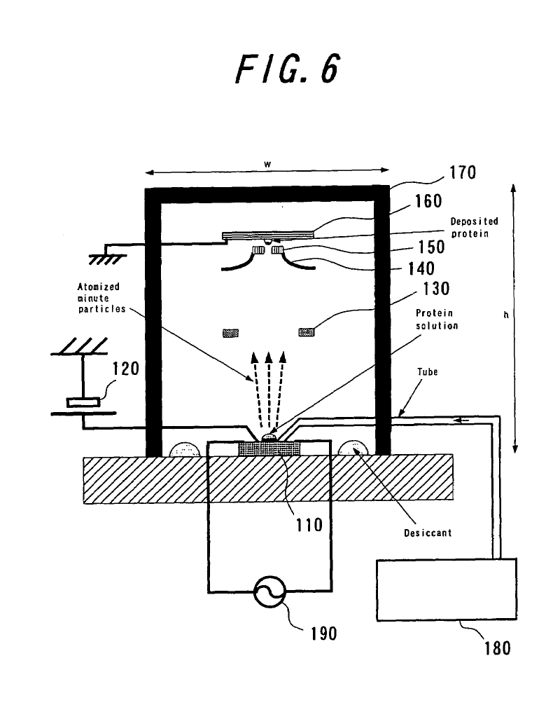

FIG. 7 is an exploded perspective view showing parts constituting micro-pattern forming apparatus shown in FIG. 6. In other word, FIG. 7 is a three-dimensional assembling view of parts such as for atomization or formation of chips, constituting micro-pattern forming apparatus. FIG. 7 is a perspective view, i.e. three-dimensional assembling view clearly illustrating parts, which are not clear in the two-dimensional schematic view shown in FIG. 6

Various kinds of atomizer 110 shown in FIG. 6 may be used. As illustrated in FIG. 7, the atomizer 110 comprises piezo substrate 111 (piezoelectric vibrator), monolithic structure 112 having a mesh with a plurality of holes equally spaced (a structure combined with a mesh and a spacer), a push plate 113 and a comb-shaped electrode called IDT 114 (Inter Digital Transducer). When the predetermined high-frequency signal is provided by the high-frequency power supply, the electrical signal is converted into an acoustic wave and the surface acoustic wave is propagated on the piezo substrate 111. The solution of protein provided on the substrate 111 enters the gap between the mesh 112 and the piezo substrate 111 by SAW stream of surface acoustic wave by IDT 114 and the piezo substrate 111, therefore, the solution keeps even thickness thereof to be atomized easily. The surfaces of the piezo substrate 111, IDT 114 or mesh 112 are subjected hydrophilic treatment (or lipophilic/hydrophobic treatment) depending on the properties of the solution to be used, wettability to the solution is improved so as to improve the atomization state, that is to say, to achieve miniaturization or equalization of the particle diameter of particulates. In addition, hydrophilic (hydrophobic) film/layer may be attached.

Although a paper by Minoru Kurosawa, Toshio Higuchi et al. (“Surface Acoustic Wave Atomizer”, Sensors and Actuators A 50, 1995, pp. 69-74) describes if a solution layer on a substrate is equal to or more than 1 mm, the solution can not be atomized, it is possible to atomize a solution, in which even if a solution layer is equal to or more than 1 mm, depending on conditions. Although sizes of the atomized particulate substances depend mainly on vibrating conditions, the particle sizes may be determined by other conditions such as sizes of holes in the mesh. Although in this embodiment the mesh having holes with a diameter of 10 μm is used, it can be modified as needed and a desired particle size can be obtained by controlling the sizes of the holes in the mesh.

The high-voltage power supply 120 shown in FIG. 7 is electrically connected to the conductive mesh or spacer and serves to charge the solution and/or the atomized particulates. In this embodiment, the power supply of direct current 500 V power supply is used while wider range of voltage may be used practically. However, the voltage is preferably optimized because it affects the collection efficiency/membrane material/activation of the formed protein chip.

As shown in FIG. 7, five collimator electrodes (131, 132, 133, 134 and 135) are provided in this embodiment while one or more collimator electrodes may be provided. The shape, quantity and interspace of the collimator electrodes affect the collection efficiency/membrane material/activation of the formed micro-pattern chip, therefore, it is preferably optimized. In this case, as shown in the figure, it is preferable that the closer to the sample holder each electrode is placed, the smaller the inner diameter of the collimator electrodes is made, so as to collect the particulates toward the sample holder. In the embodiment, the inner diameters of the collimator electrodes 131, 132, 133 and 134 are respectively 80 mm, 75 mm, 70 mm and 65 mm.

It is also preferable that the voltage provided to each collimator electrode is set less and less as each collimator electrode become close to the sample holder 160 (a substrate for sample deposit). For example, in the embodiment, when the high-voltage power supply 120 is 5000 V direct current, appropriate resistors are provided in the circuit as shown in the figure and the electrodes 131, 132, 133, 134 and 135 are set respectively 4000 V, 3000 V, 2000 V, 1000 V and 500 V so as to be optimized.

The fluorocarbon resin shield 140 shown in FIG. 7 also serves as a mask and functions to improve the collection efficiency. The charged solution or the dried particulates in flying (the charged protein) are attached to the fluorocarbon resin shield 140 to form the charged layer with a certain degree of thickness. After that, the new charged protein is not attached to the fluorocarbon resin shield 140 due to the electro statically repulsive force between the charged layer and the charged protein and go toward the mask 150 to obtain high collection efficiency. The mask 150 used in the experiment is the same as the fine mask used in the embodiment 1.

Preferably, the surface of the sample holder 160 shown in FIG. 7 is electrically conductive in order to discharge, i.e., to ground the electricity of the deposited charged protein. For example, ITO glass, aluminum coated PET (polyethylene terephthalate), stainless or single-crystal metal are preferably used for the sample holder 160. When only micro-pattern formed by protein is independently used, PVP, EDTA or the like are preferably coated on the surface of the sample holder 160 to peel off the deposited micro-pattern easily.

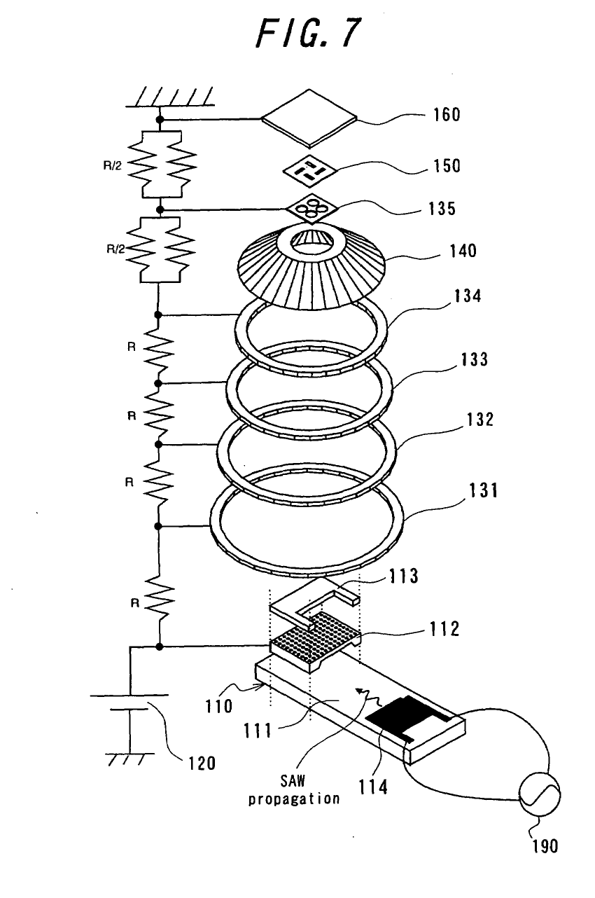

FIG. 8 is a perspective view showing the configuration of an atomizer as electrospray means according to the present invention, which provided with wires as a charging means. As illustrated, the atomizer 210 consists of a SAW substrate 211, IDT 214 provided on the surface thereof and wires 217. The left surface region of the substrate 211, mainly from which the solution is atomized and spattered, will be called an atomizing area 216. The wires 217, which are connected to the high-voltage power supply, are provided in contact with or near this atomizing area 216. It is preferable that the wires 217 are not in contact with the surface of the substrate 211 and small gap is provided between the wires 217 and the substrate 211. If they are made contacts, the attenuation of the vibration of the substrate 211 may be caused. When the prescribed voltage is applied to the wires 217, the solution of protein and/or the atomized fine particulates are charged to form charged particulates at the atomizing area 216. Alternatively, if vibration and charging are provided simultaneously, the charged fine droplets are atomized to be particulates in flying when they are rapidly dried.

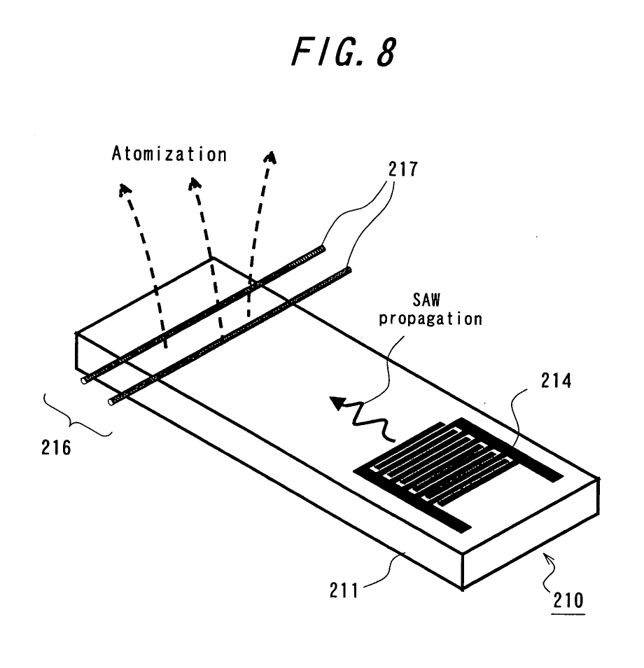

FIG. 9A is a schematic diagrams, seen on cross section, for schematically showing a principle of a atomizer in the micro-pattern forming apparatus according to the present invention, and FIG. 9B is a schematic perspective view depicting the atomizer of FIG. 9A. Namely, these drawings are schematic diagram illustrating the micro-pattern forming apparatus using the atomization phenomenon of combined effect caused by both “vibration” and “applying electrical field”. When a protein solution is supplied onto the vibrating element, the solution receives the SAWs from the vibrating element, waves as shown are generated, and to form an endless number of crests 320 of wave in succession. In other words, a great number of prongs like a tip of a capillary are formed on the solution surface. On the other hand, the wires 310 are connected to a high voltage power source (not shown), and a high voltage is applied to the solution. The electrical charges generated by this applying will focus on crests (prongs) of wave 320, which are generated by the vibration, of the solution. A piece of the solution, on which the electrical charges focus on, will electrostatically jump out of the crests 320 upward as charged minute particulate substances 330. During the jumped out charged minute particulate substances 330 fly to a substrate 350 for depositing sample, which is grounded, a solvent(s) or water is dried off and thus the particles will decrease its particle size. Additionally, the particulate substances 330 may split into pieces by electrical repulsive force within each particles 330.

As a result, the particulate substances 330 are deposited or immobilized on the substrate 350 for depositing/immobilizing sample, which faces the vibrating element 300 for depositing/immobilizing sample, in a dry form as spots 340.

As above, the present invention is that the solution on the vibrator substrate ruffles by vibration, countless protrusions are formed simultaneously voltage is applied to the solution by the high-voltage power supply, the formed countless protrusions are intensively charged and the solution is made to be the charged fine particulates and atomized electrostatically.

Furthermore, on the vibrator, atomization only by vibration and atomization only by applying voltage may be simultaneously generated other than atomization by static electricity. The vibrator can vibrate intermittently. In addition, the vibrator may be an ultrasonic vibrator, an electrostatic vibrator, a piezoelectric vibrator, a magnetostrictive vibrator, an electrostriction vibrator or an electromagnetic vibrator. A piezoelectric vibrator may use a monostratal piezoelectric element, a stacked piezoelectric element or a single crystal piezoelectric element. In addition, a piezoelectric vibrator may be a resonant vibrator, a surface acoustic wave vibrator, a longitudinal vibrator, a transverse (slip) vibrator, a radial vibrator, a longitudinal vibrator or a thickness direction (non-longitudinal type) vibrator. A surface acoustic wave vibrator preferably comprises one or more inter digital transducers.

### Embodiment 3

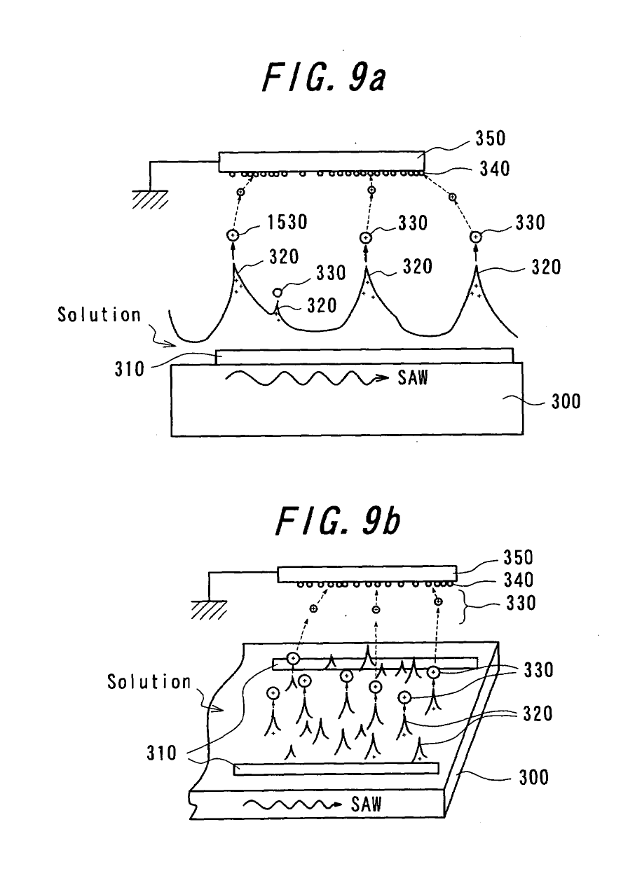

FIG. 10 is a photograph in substitution for a drawing showing a SEM micrograph of an organic micro-pattern structure formed by the micro-pattern forming apparatus according to the present invention. Invertase (protein) 2.5 g/L is sprayed in 3 minutes with the micro-pattern forming apparatus by ESD method to form a micro-pattern structure and this SEM micrograph is taken of the formed micro-pattern structure by a high-resolution scanning electron microscope. As shown, it is observed that particles having about 200 nm diameter are obtained.

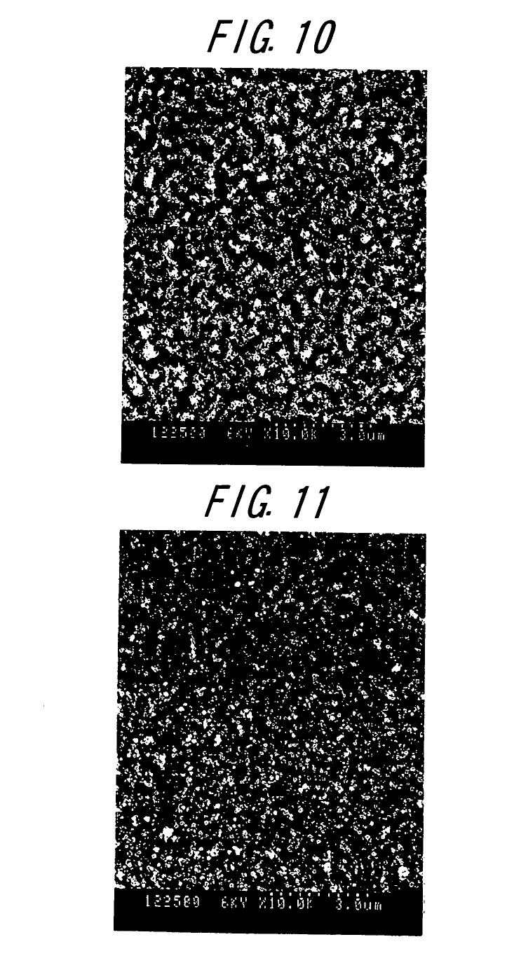

FIG. 11 is a SEM micrograph of an organic micro-pattern structure formed by the micro-pattern forming apparatus according to the present invention. Invertase (protein) 0.5 g/L is sprayed/atomized in 30 minutes with the micro-pattern forming apparatus by ESD method to form a micro-pattern structure and this SEM micrograph is taken of the formed micro-pattern structure by a high-resolution scanning electron microscope. As shown, it is observed that particles having approximately 100 nm diameter are obtained.

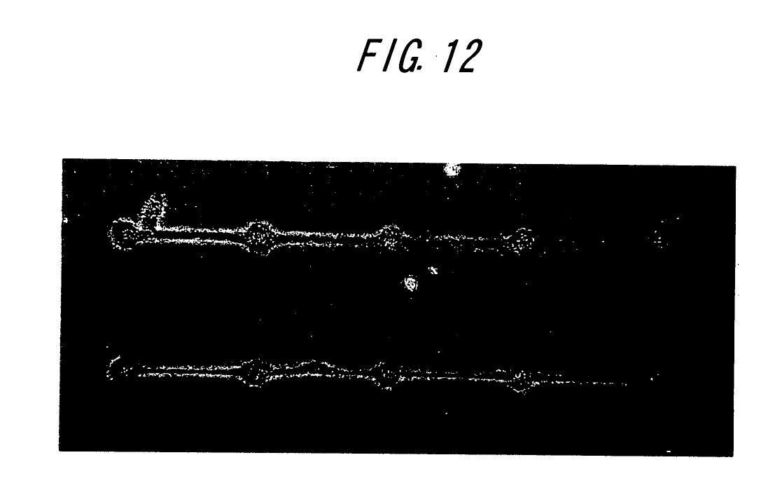

FIG. 12 is a SEM micrograph of an organic micro-pattern structure formed by the micro-pattern forming apparatus according to the present invention. Alq3 (0.1 weight percent in DMF, 8-Hydroxyquinoline aluminum salt, Aldrich) is sprayed/atomized in 30 minutes with the micro-pattern forming apparatus by ESD method to form a micro-pattern structure and this SEM micrograph is taken of the formed micro-pattern structure by a high-resolution scanning electron microscope. The Alq3 is a luminescent material which can be used for an organic EL panel. As shown, it is observed that the formed pattern has lines of approximately 3-10 μm in line width. The narrowest line of the pattern in FIG. 12 is approximately 3 μm, which demonstrates that a fine pattern can be formed.

While the present invention has been described as above with reference to attached drawings and embodiments, it is to be noted that those skilled in the art could easily make various changes and modification based on the present disclosure. Therefore it is to be understood that these changes and modifications are within the scope of the present invention. For example, each member, each means and functions included in each steps are enable to be re-disposed without logical errors and a plurality of means or steps are enable to be combined or separated.

1. A micro-pattern forming apparatus comprising:
electrospraying means for applying a voltage to a solution containing a sample to electrostatically atomize the solution;
supporting means for supporting a chip, on which the sample in the solution electrostatically atomized by said electrospraying means is to be deposited; and
fine masking means disposed between said electrospraying means and said supporting means, having a mask pattern for being passed through by said electrostatically atomized solution in order to form a micro-pattern of said sample upon said chip, said mask pattern being made from a photoresist material with concavity and convexity on the side of said supporting means.

2. A micro-pattern forming apparatus according to claim 1, wherein said electrospraying means uses at least one capillary.

3. A micro-pattern forming apparatus according to claim 1, wherein said electrospraying means uses at least one vibrating element to vibrate said solution.

4. A micro-pattern forming apparatus according claim 1, wherein the concavity and convexity formed in the mask pattern of said fine masking means is formed by:
forming a pattern for forming concavity and convexity made from a photoresist material, with use of lithography;
forming a fluorocarbon layer on this pattern for forming concavity and convexity, with use of reactive ion etching;
forming said mask pattern comprising a photoresist material on the fluorocarbon layer, with use of lithography; and
peeling said mask pattern off from said fluorocarbon layer on said substrate.

5. A micro-pattern forming apparatus according to claim 1, wherein the fine masking means has at least one reinforcing rib made from a photoresist material.

6. A micro-pattern structure formed by a micro-pattern forming apparatus according to claim 1, wherein said micro-pattern structure comprises a cluster including particles of at least one organic material of several tens of nanometers.

7. A method of manufacturing a micro-pattern structure of at least one organic material by a micro-pattern forming apparatus according to claim 1.
